(19) United States
(12) Patent Application Publication
(10) Pub. No.: US 2018/0142673 A1
(43) Pub. Date: May 24, 2018

(54) VERTICAL AXIS WIND TURBINE WITH AUTOMATIC ADJUSTMENT OF BLADE ANGLE BASED ON CENTRIFUGAL FORCE

(71) Applicant: KAI-MING WU, Hsinchu County (TW)

(72) Inventors: KAI-MING WU, Hsinchu County (TW); CHAN-YU WU, Hsinchu County (TW)

(21) Appl. No.: 15/821,541

(22) Filed: Nov. 22, 2017

(30) Foreign Application Priority Data
Nov. 24, 2016 (TW) 105138724

(51) Int. Cl. F03D 3/06; F03D 3/00

(52) U.S. Cl. CPC F03D 3/068; F03D 3/007

(57) ABSTRACT

The invention disclosed a vertical axis wind turbine with automatic blade adjustment of blade angle, comprising a pillar, a rotational axis disposed at the pillar, and a plurality of wind turbine assemblies rotating around the pillar. Each wind turbine assembly comprises a blade, a support, and a swing axis. The swing axis comprises an axial core element and an axis element, fixed to the blade and uses the axial core element to engage the support to make the blade to swing on the axial core element with an angle within ±90°. The blade comprises first and second blade areas, with an imaginary line of center of gravity dividing first and second blade areas. When the blade is at 0°, the imaginary line overlaps the projection of centrifugal force direction of an extension line of axis of the swing axis, but the line shall not actually overlap the extension line.

### CROSS-REFERENCE TO RELATED APPLICATION

The present application is based on, and claims priority form, Taiwan Patent Application No. 105138724 filed Nov. 24, 2016 the disclosure of which is hereby incorporated by reference herein in its entirety.

### TECHNICAL FIELD

The technical field generally relates to a vertical axis wind turbine (VAWT) with automatic adjustment of blade angle based on centrifugal force.

### BACKGROUND

The wind turbine utilizes the wind to rotate the wind blades to drive the generator to generating power. As such, the wind blade to be rotated by the wind must be set up in a direction so that the wind can act on the wind blade to rotate. However, as the direction of the wind changes in different weathers, seasons, and other environmental factors, the conventional wind turbine is often constructed with a horizontal axis structure, whose windward side must be adjusted often due to wind change. However, the problems of large size, high setup cost and high maintenance cost are among the issues need to be addressed. On the other hand, the smaller wind turbines, while having vertical axis structure not affected by wind change, mostly have the blades with non-adjustable angles. Therefore, when the wind becomes smaller, the blades cannot utilize the Bernoulli effect and the efficiency is reduced. Although some models proposed additional adjustment function, as shown in FIG. 1, the structure often requires extra auxiliary elements to achieve adjustment function, such as spring or linkage elements, which not only increases the cost of wind turbine, but also causes maintenance overhead due to frequent damage.

### SUMMARY

An embodiment of the present invention provides a vertical axis wind turbine (VAWT) with automatic adjustment of blade angle based on centrifugal force, comprising: a plurality of wind turbine assemblies, a rotational axis, and a pillar. Each wind turbine assembly comprises a blade, at least a support, and at least a swing axis. The support has a first end fixed to the rotational axis and a second end disposed with at least a swing axis. The rotational axis is disposed at the pillar, and the wind turbine assembly rotates around the pillar. The swing axis comprises an axial core element and an axis element. The axis element is fixed to the blade and uses the axial core element to engage the second end of the support to make the blade to swing on the axial core element of the swing axis, with a swinging angle within ±90°. The blade comprises a first blade area and a second blade area, with a line of center of gravity dividing the first and second blade areas. The line of center of gravity is an imaginary line passing through the center of gravity of the blade. The first blade area is smaller than the second blade area. When the blade is at 0°, the line of center of gravity must overlap with the projection of centrifugal force direction of an extension line of axis of the swing axis, but the line of center of gravity shall not actually overlap the extension line of the axis.

When the blade is at 0°, the blade is perpendicular to the centrifugal force direction; the distance between the extension line of the axis of the swing axis and the center of gravity of the blade must be greater than 0.

The vertical axis wind turbine with automatic adjustment of blade angle further comprises a stopper, disposed at an appropriate location on the blade, the support, the swing axis or the rotational axis.

When the stopper is at 45°, an optimal activation reactive force is achieved.

The blade has a front end of an arc shape, and a body of a shape of airplane wing or plate. Either way, the shape of the blade must be streamlined in accordance with fluid mechanics.

The blade is made of a frame and a soft material, wherein the soft material, such as canvas, is fixed to the left and right sides of the frame.

The support is a string suspension structure, with two ends using strings to hang the blades enabling the blade and swing under the effect of wind. The string suspension structure comprises at least an arc support or a U-shape support and at least a string suspension element. The string suspension element passes through the blade or through a suspension arm fixed to the blade to fasten the blade. The two ends of the string suspension element are fixed respectively to the arc support or the U-shaped support. The string suspension structure uses the arc shape support and the string suspension element to provide a tension force. When the wind changes direction, the tension force, in combination with the centrifugal force, adjusts the angle of the blade accordingly and rapidly.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a wind turbine with adjustable blades;

FIG. 2 shows a schematic view of a vertical axis wind turbine with automatic adjustment of blade angle based on centrifugal force according to the present invention;

FIG. 3A shows a schematic view of the swing axis of the blade swinging with angle within ±α°;

FIG. 3B and FIG. 3C show top views of the blade swinging with angle within ±45°;

FIG. 4 shows a schematic view of at least a stopper disposed at the support according to the present invention;

FIG. 5 shows a top view of the blade of the VAWT with automatic adjustment of blade angle before and after under the effect of the wind;

FIG. 6 shows a schematic view of a blade of a plate shape;

FIG. 7 shows a schematic view of a blade comprising a frame and a soft material;

FIG. 8 shows a schematic view of an embodiment using string to hang the blade; and

FIG. 9 shows a schematic view of another embodiment using string to hang the blade.

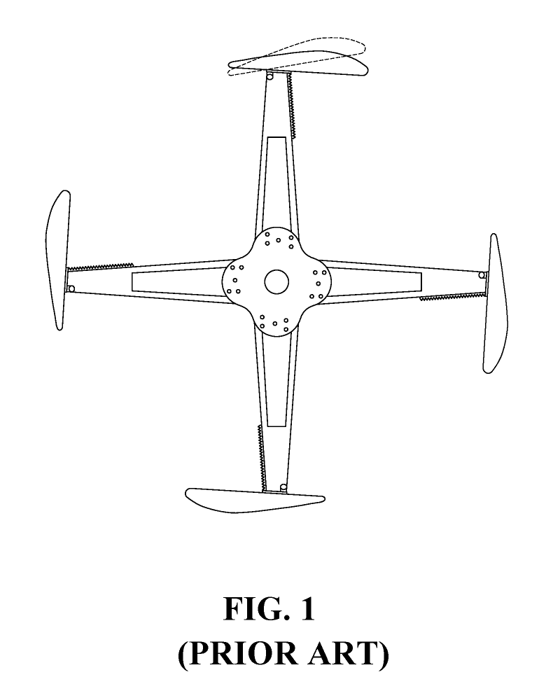

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The vertical axis wind turbine (VAWT) of the present invention utilizes the balance between the wind and the centrifugal force to change the angle of the blade with respect to the wind (i.e., upwind angle), so the wind turbine under a breeze conditions could maximize the efficiency of the wind turbine.

The VAWT can be categorized as lifting-force type and drag-force type. The lifting-force type wind turbine provides higher energy transformation efficiency, but is hard to start at low wind speed. The drag-force type wind turbine can start at low wind speed, but achieves only low energy transformation efficiency. The present invention utilizes the balance between the wind and the centrifugal force to automatically adjust the angle of the blade to achieve the ability to start at low wind speed, and utilizes Bernoulli's principle to generate lifting force to accelerate the rotation of the wind turbine at high wind speed.

The wind turbine of the present invention uses the blades which are free to swing. Because the areas on the blade before and behind the fulcrum of the blade are asymmetrical, which resulting in deflection, the deflected blade caused by wind generates a reaction force due to the rebound wind, which pushes the blade to move. When the blade moves along a circumference and generates a centrifugal force, the cut-in angle of the wind changes constantly and the blade constantly adjusts the angle facing the windward because of the balance of the wind and the centrifugal force to achieve the optimal reaction force. When the centrifugal force is large, which implies a higher rotation speed, the deflection of the blade becomes smaller. Under the Bernoulli's principle, a lifting force is generated and the wind turbine becomes a lifting-force type wind turbine, which can achieve higher energy transformation efficiency.

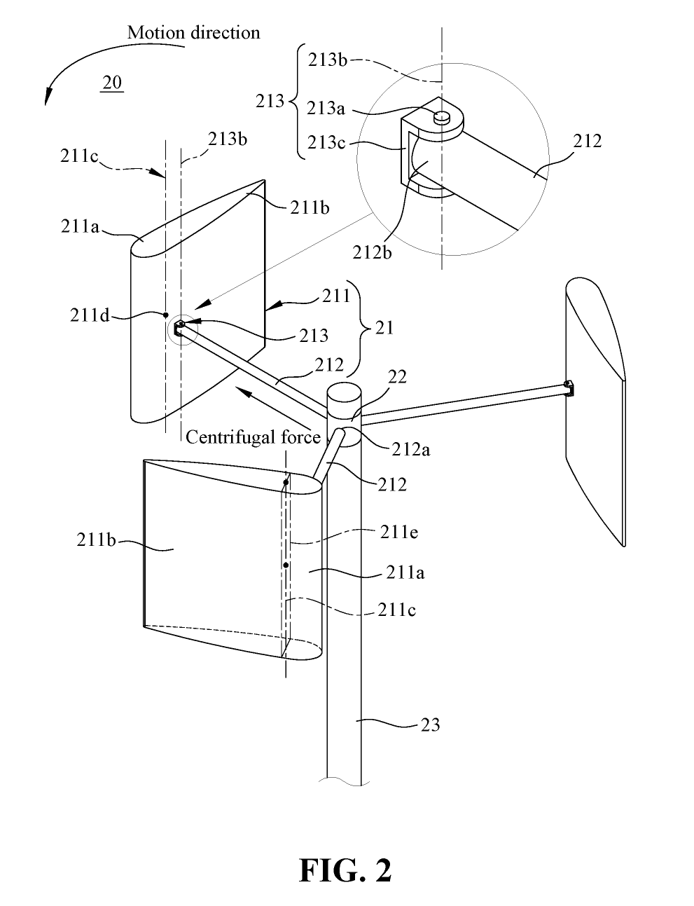

FIG. 2 shows a schematic view of an embodiment of a vertical axis wind turbine with automatic adjustment of blade angle based on centrifugal according to the present invention. As shown in FIG. 2, the vertical axis wind turbine with automatic adjustment of blade angle 20 comprises: a plurality of wind turbine assemblies 21, a rotational axis 22, and a pillar 23. Each wind turbine assembly 21 comprises a blade 211, at least a support 212, and at least a swing axis 213. The support 212 has a first end 212a fixed to the rotational axis 22 and a second end 212b disposed with at least a swing axis 213. The rotational axis 22 is disposed at the pillar 23, and the wind turbine assembly 21 rotates around the pillar 23. The swing axis 213 comprises an axial core element 213a and an axis element 213c. The axis element 213c is fixed to the blade 211 and uses the axial core element 213a to engage the second end 212b of the support 212 to make the blade 211 to swing on the axial core element 213a of the swing axis 213, with a swinging angle within ±90°. The blade 211 comprises a first blade area 211a (headwind) and a second blade area 211b, with a line 211c of center of gravity dividing the first and second blade areas 211a, 211b. The line 211c of center of gravity is an imaginary line passing through the center of gravity 211d of the blade 211. The first blade area 211a is smaller than the second blade area 211b. When the blade 211 is at 0°, the line 211c of center of gravity must overlap with the projection of centrifugal force direction of an extension line 213b of an axis of the swing axis 213, but the line 211c of center of gravity shall not actually overlap the extension line 213b of the axis.

Wherein, the following describes how the line 211c of the center of gravity divides the first blade area 211a and the second blade area 211b. The line 211c of center of gravity extends towards the symmetrical part on the two opposite sides of the blade 211 to form a virtual cross-section 211e. The virtual cross-section 211e (shown as dash line rectangle) divides the blade 211 into two portions—a front portion and a rear portion. The outside area of the front portion (headwind) is the first blade area 211a, and the outside area of the rear portion is the second blade area 211b.

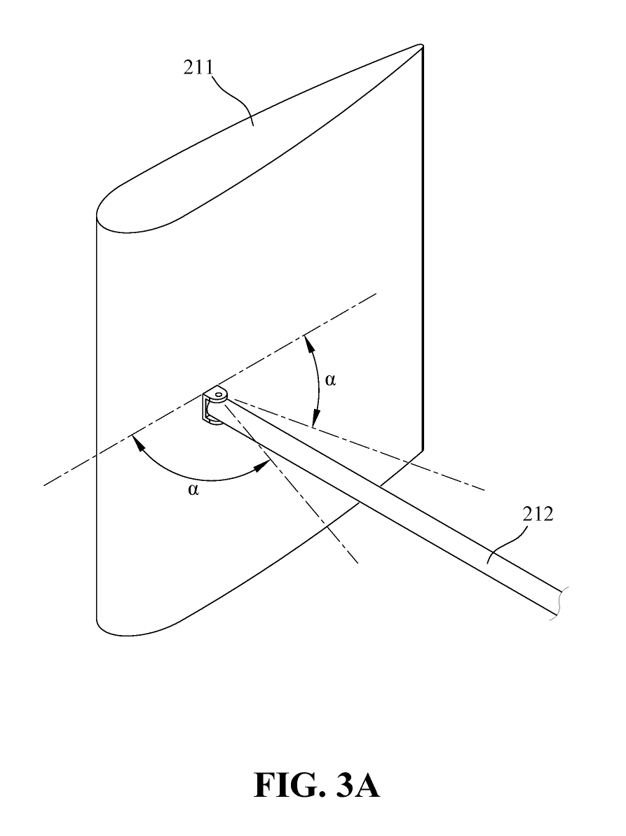

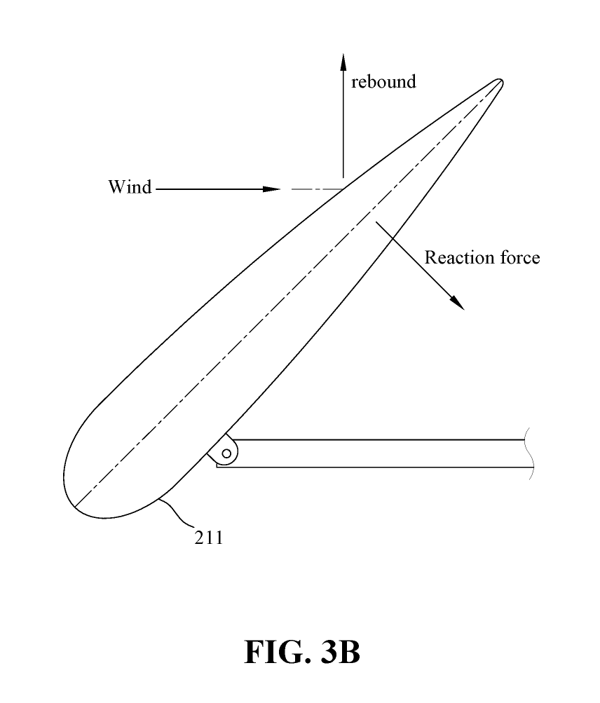

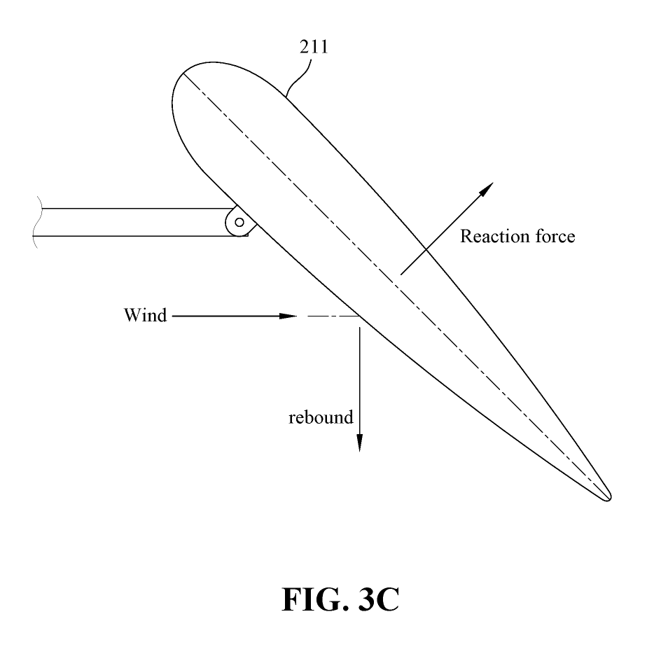

FIG. 3A shows a schematic view of the swing axis of the blade swinging with angle within ±α°. As shown in FIG. 3A, the blade 211 is disposed at the support 212 and is allowed to swing within ±α° angle. When the wind changes direction, the blade 211 also changes direction under the influence of the wind. When the blade 211 swings, the swing angle is within ±α°.

FIG. 3B and FIG. 3C show top views of the blade swinging with angle within ±45°. Refer to both FIG. 3B and FIG. 3C, wherein FIG. 3B and FIG. 3C respectively describe that an initial wind causes the blade to deflect, and the optimal deflection angle of the vertical axis wind turbine is ±45° so that the wind turbine can achieve the optimal activation efficiency.

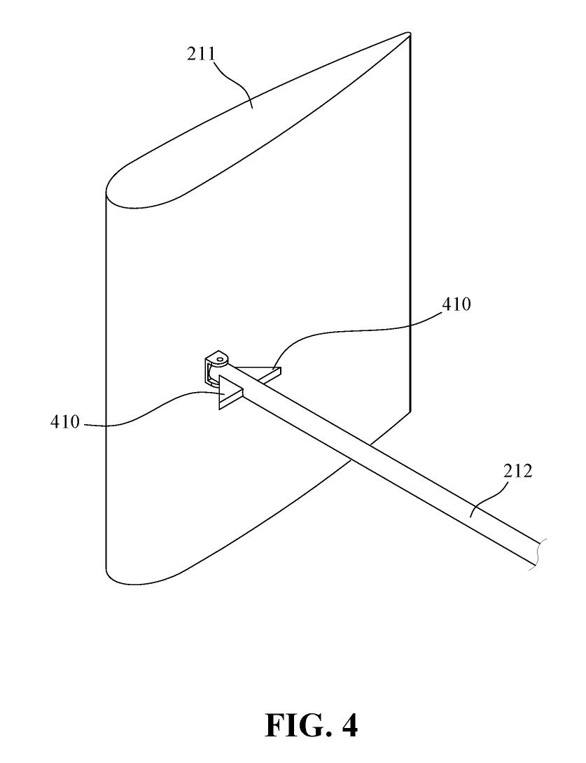

The vertical axis wind turbine with automatic adjustment of blade angle further comprises a stopper. FIG. 4 shows a schematic view of at least a stopper disposed at the support according to the present invention. As shown in FIG. 4, the support 212 is disposed with at least a stopper 410. The at least stopper 410 can set the activation swing angle of the blade 211. When the wind blows, the blade 211 swings due to the wind. Because of the stopper 410, the blade 211 deflects to an angle. The deflection angle causes the blade 211 to obtain a reaction force to push the blade 211. As such, the self-start is achieved.

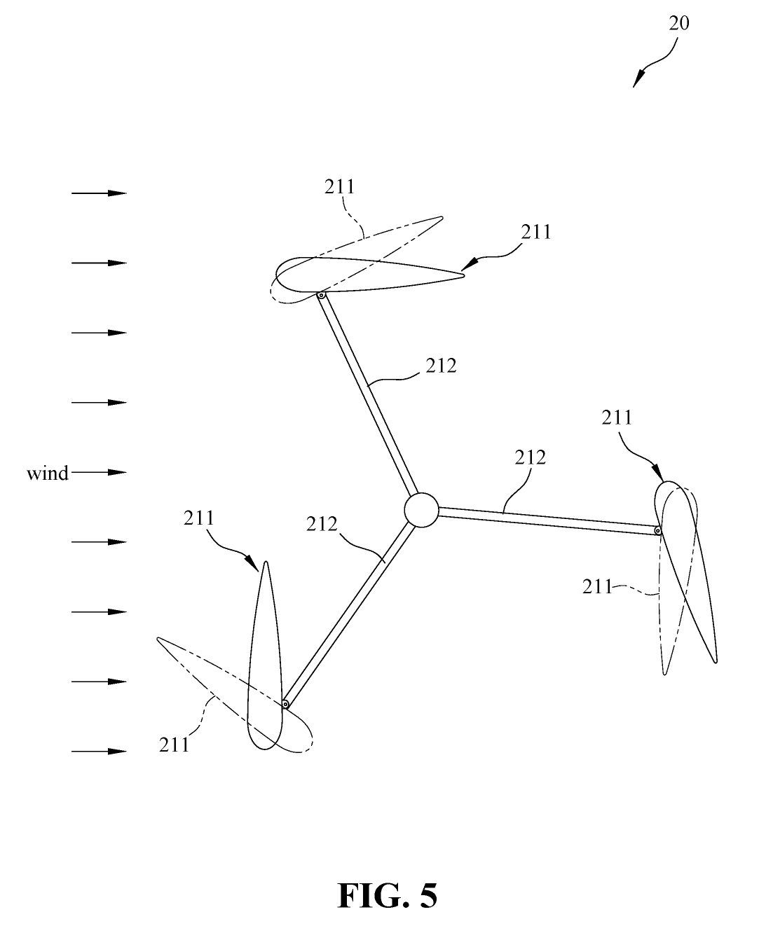

FIG. 5 shows a top view of the blade of the VAWT with automatic adjustment of blade angle under the effect of the wind. As shown in FIG. 5, the VAWT 20 with automatic adjustment of blade angle, under the influence of the wind (shown as the arrows) changes the original position (indicated by dash line) of the blade 211 to a new position (solid line). In the figure, the three blades 211 are located at three different positions with respect to the wind direction. Under the balance influence of the wind and the centrifugal force, the angle changes of the three blades 211 are also different.

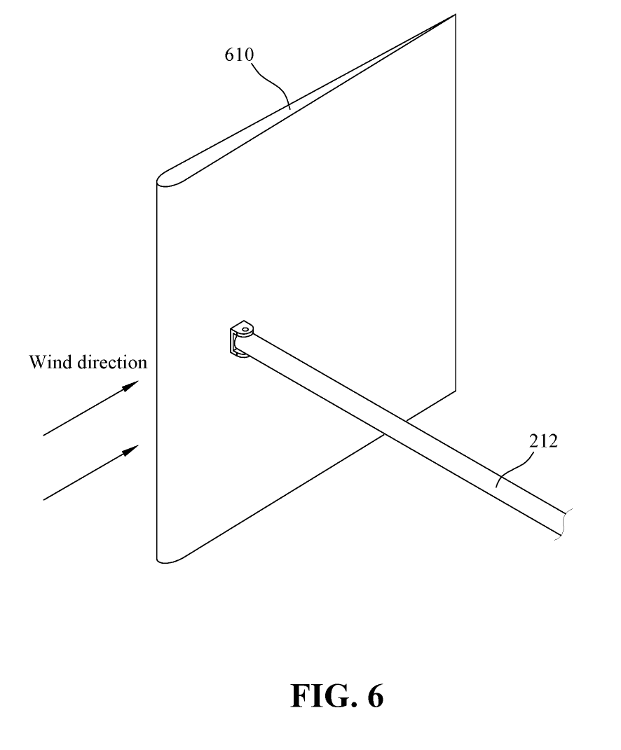

FIG. 6 shows a schematic view of a blade of a plate shape. As shown in FIG. 6, the blade 610 is a streamlined design. The front end (headwind) of the blade 610 has an arc shape, and the body of a shape of airplane wing, or plate. Either way, the shape of the blade 610 must be streamlined in accordance with fluid mechanics to achieve low wind resistance.

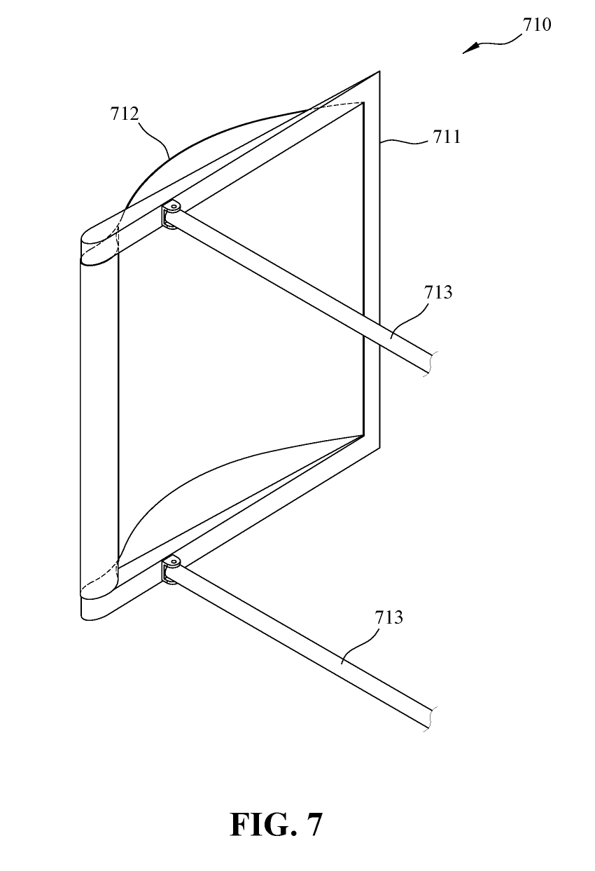

FIG. 7 shows a schematic view of a blade comprising a frame and a soft material. As shown in FIG. 7, the blade 710 is made of a frame 711 and a soft material 712, wherein the frame 711 is fixed to the support 713, and the soft material 712, such as canvas, is fixed to the left and right sides of the frame 711.

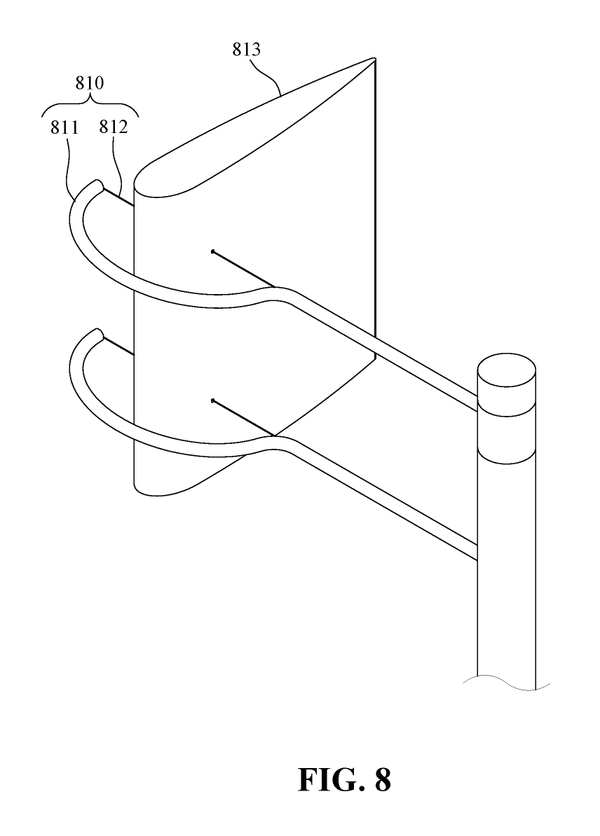

FIG. 8 shows a schematic view of an embodiment using string to hang the blade. As shown in FIG. 8, the support 810 comprises at least an arc support 811 and at least a string suspension element 812. The string suspension element 812 passes through the blade 813, and the two ends of the string suspension element 812 are fixed respectively to the arc support 811.

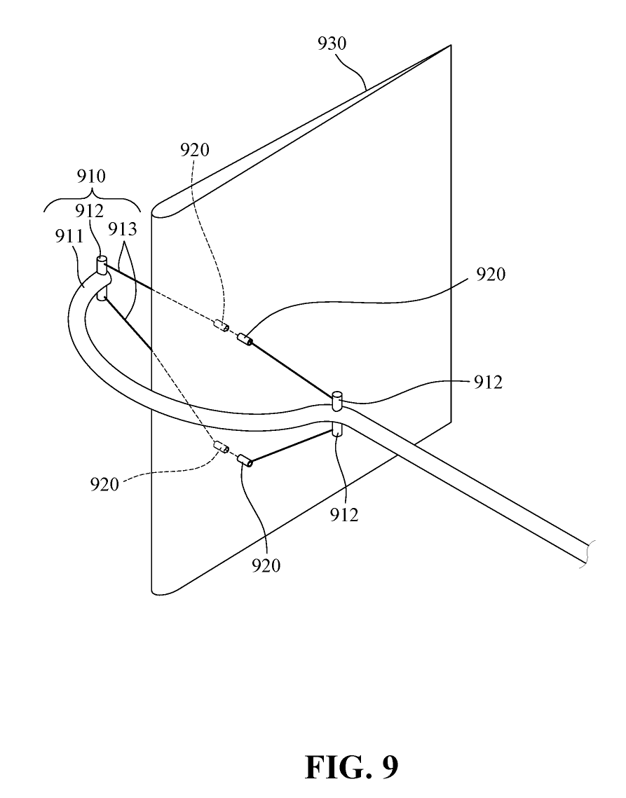

FIG. 9 shows a schematic view of another embodiment using string to hang the blade. As shown in FIG. 9, the support 910 comprises an arc support 911, at least a fixed portion 912, and at least a string suspension element 913. At least a suspension arm 920 passes through the blade and fixed to the blade 930. The fixed portion 912 is disposed at the arc support 911, the string element 913 passes through the suspension arm 920, and the two ends of the string suspension element 913 are fixed to the fixed portion 912. The string suspension structure uses the arc shape support 911 and the string suspension element 913 to provide a tension force. When the wind changes direction and the blade 930 deflects due to the wind, the tension force and the centrifugal force, adjusts the angle of the blade 930 accordingly and rapidly. The arc support can be a U-shaped support.

In summary, the VAWT utilizes the balance between the wind power and the centrifugal to change the direction of the blade so that the wind turbine can start even in a breeze environment. Also, the wind turbine can be placed in ocean with a slow ocean current to generate power. The present invention can provide industrial and commercial values.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A vertical axis wind turbine (VAWT) with automatic adjustment of blade angle, comprising: a plurality of wind turbine assemblies, a rotational axis, and a pillar;
each wind turbine assembly comprising a blade, at least a support, and at least a swing axis;
the support having a first end fixed to the rotational axis and a second end disposed with at least a swing axis;
the rotational axis being disposed at the pillar, and the wind turbine assembly rotating around the pillar;
the swing axis comprising an axial core element and an axis element, the axis element being fixed to the blade and using the axial core element to engage the second end of the support to make the blade to swing on the axial core element of the swing axis, with a swinging angle within ±90°;
wherein the blade comprising a first blade area (headwind) and a second blade area, with a line of center of gravity dividing the first and second blade areas; the line of center of gravity being an imaginary line passing through the center of gravity of the blade, and the first blade area being smaller than the second blade area; when the blade being at 0°, the line of center of gravity overlapping with the projection of centrifugal force direction of an extension line of an axis of the swing axis, but the line of center of gravity not actually overlapping the extension line of the axis.

2. The VAWT with automatic adjustment of blade angle as claimed in claim 1, wherein when the blade is at 0°, the blade is perpendicular to the centrifugal force direction.

3. The VAWT with automatic adjustment of blade angle as claimed in claim 1, wherein the distance between the extension line of the axis of the swing axis and the center of gravity of the blade must be greater than 0.

4. The VAWT with automatic adjustment of blade angle as claimed in claim 1, further comprising a stopper, disposed at an appropriate location on the blade, the support, the swing axis or the rotational axis.

5. The VAWT with automatic adjustment of blade angle as claimed in claim 4, wherein when the stopper is at 45°, an optimal activation reactive force is achieved.

6. The VAWT with automatic adjustment of blade angle as claimed in claim 1, wherein the blade has a front end of an arc shape, and a body of a shape of airplane wing or plate; the shape of the blade must be streamlined in accordance with fluid mechanics.

7. The VAWT with automatic adjustment of blade angle as claimed in claim 1, wherein the blade is made of a frame and a soft material, wherein the soft material is fixed to the corresponding left and right sides of the frame.

8. The VAWT with automatic adjustment of blade angle as claimed in claim 1, wherein the support comprises at least an arc support and at least a string suspension element;
the string suspension element passes through the blade directly or through a suspension arm fixed to the blade to fasten the blade; the two ends of the string suspension element are fixed respectively to the arc support, and uses a tension force to hang and fixed the blade to the arc support enabling the blade is perpendicular to the direction of centrifugal force.

9. The VAWT with automatic adjustment of blade angle as claimed in claim 8, wherein the arc support is a U-shaped support.
